(19) United States
(12) Patent Application Publication
(10) Pub. No.: US 2015/0127473 A1
(43) Pub. Date: May 7, 2015

(54) SYSTEM AND METHOD FOR PROVIDING A BIDDING PLATFORM RESPECTIVE OF A USER INTENT

(71) Applicant: DOAT MEDIA LTD., Tel Aviv (IL)

(72) Inventors: Joey Joseph Simhon, Ramat-Gan (IL); Amir Taichman, Haifa (IL); Dvir Volk, Tel Aviv (IL); Noam Yasour, Tel Aviv (IL)

(73) Assignee: DOAT MEDIA LTD., Tel Aviv (IL)

(21) Appl. No.: 14/594,345

(22) Filed: Jan. 12, 2015

Related U.S. Application Data
(63) Continuation-in-part of application No. 14/333,710, filed on Jul. 17, 2014.
Application No. 14/333,710 is a continuation-in-part of application No. 13/712,563, filed on Dec. 12, 2012.
Application No. 13/712,563 is a continuation-in-part of application No. 13/156,999, filed on Jun. 9, 2011.
Application No. 13/156,999 is a continuation-in-part of application No. 13/296,619, filed on Nov. 15, 2011.
Application No. 14/333,710 is a continuation-in-part of application No. 13/156,999, filed on Jun. 9, 2011.
Application No. 14/333,710 is a continuation-in-part of application No. 13/296,619, filed on Nov. 15, 2011.
(60) Provisional application No. 61/927,542, filed on Jan. 15, 2014.
(60) Provisional application No. 61/856,066, filed on Jul. 19, 2013.
(60) Provisional application No. 61/653,562, filed on May 31, 2012.
(60) Provisional application No. 61/354,022, filed on Jun. 11, 2010.
(60) Provisional application No. 61/468,095, filed on Mar. 28, 2011.

(51) Int. Cl. G06Q 30/02; G06F 17/30

(52) U.S. Cl. CPC G06Q 30/0275; G06F 17/30864
USPC 705/14.71

(57) ABSTRACT

A system and method for generating real-time bids based on a user intent. The system comprises: receiving at least one variable from a user device; determining a user intent of a user of the user device at least based on the at least one variable; selecting a plurality of resources of information respective of the user intent; generating, in real-time, an opening bid to purchase at least one display segment on a display of the user device at least based on the user intent; and sending the opening bid to a plurality of operators of the plurality of resources of information.

### CROSS-REFERENCE TO RELATED APPLICATIONS

This application claims the benefit of U.S. Provisional Application No. 61/927,542 filed on Jan. 15, 2014. This application is a continuation-in-part of U.S. patent application Ser. No. 14/333,710 filed on Jul. 17, 2014, now pending, which claims the benefit of U.S. Provisional Application No. 61/856,066 filed on Jul. 19, 2014. The Ser. No. 14/333,710 application is also a continuation-in-part of:

(a) U.S. patent application Ser. No. 13/712,563 filed on Dec. 12, 2012, now pending, which claims the benefit of U.S. Provisional Patent Application No. 61/653,562 filed on May 31, 2012. The Ser. No. 13/712,563 application is also a continuation-in-part of the below-referenced U.S. patent application Ser. Nos. 13/156,999 and 13/296,619;

(b) U.S. patent application Ser. No. 13/156,999 fled on Jun. 9, 2011, now pending, which claims the benefit of U.S. Provisional Patent Application No. 61/354,022 filed on Jun. 11, 2010, and U.S. Provisional Patent Application No. 61/468,095 filed on Mar. 28, 2011; and

(c) U.S. patent application Ser. No. 13/296,619 filed on Nov. 15, 2011, now pending. All of the applications referenced above are herein incorporated by reference.

### TECHNICAL FIELD

The present disclosure relates generally to purchasing items via bids on user devices, and more particularly to platforms for bidding on segments of a display on a user device respective of a user's intent.

### BACKGROUND

The Internet has become a mass media where content is largely supported by paid advertisements that are added to the content in a web-page. Typically, advertisements are displayed using portions of code written in, for example, hyper-text mark-up language (HTML) or JavaScript that are inserted into, or otherwise called up by, documents also written in HTML and which are sent to a user device for display. One of the most common types of advertisements on the Internet is a banner advertisement. Banner advertisements are generally images or animations that are displayed within a web-page. Other advertisements are simply inserted at various locations within the display area of the document. The problem with this type of advertising is that the advertisement provided to a user is frequently irrelevant to the user's needs and requirements, and as a result the user's attention is not given to them. Consequently, the advertising price of potentially valuable display area is low because its respective effectiveness is low.

Further, placements of resources, such as advertisements and links to websites are typically determined randomly without considering the user's interests and needs. For example, an advertiser may sign up to have an advertisement displayed on a user's computer at certain times and upon triggering of certain events (e.g., visiting a webpage). The advertisement may be one of several advertisements to be displayed on user devices and, as a result, the placement of any particular advertisement may be randomly determined (e.g., each time a user visits a particular website, a random advertisement of one of the website's multiple sponsors may be displayed). Advertisers would likely see any particular opportunity to provide their advertisements to a user as more valuable if they knew that the resource will be displayed on user devices of users that would be particularly interested in the advertisement (e.g., because the advertisement is relevant to a user's interests) and/or that the advertisement will be displayed prominently relevant to other displayed advertisements.

It would therefore be advantageous to provide a solution that would overcome the deficiencies of the prior art by matching an advertisement to a user intent. It would be further advantageous if such a solution allowed potential advertisers to bid on allocation of such advertisements within the display area of a user's device.

### SUMMARY

Certain disclosed embodiments include a method for generating real-time bids based on a user intent. The method comprises: receiving at least one variable from a user device; determining a user intent of a user of the user device at least based on the at least one variable; selecting a plurality of resources of information respective of the user intent; generating, in real-time, an opening bid to purchase at least one display segment on a display of the user device at least based on the user intent; and sending the opening bid to a plurality of operators of the plurality of resources of information.

Certain disclosed embodiments also include a system for generating real-time bids based on a user intent. The system comprises: an analyzer for determining a user intent of a user; a processor; and a memory communicatively connected to the processor, the memory containing instructions that, when executed by the processor, configure the system to: receive at least one variable from a user device; determine a user intent of a user of the user device at least based on the at least one variable; select a plurality of resources of information respective of the user intent; generate, in real-time, an opening bid to purchase at least one display segment on a display of the user device at least based on the user intent; and send the opening bid to a plurality of operators of the plurality of resources of information

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system for providing a bidding platform respective of a user's intent according to an embodiment;

FIG. 2 is a flowchart illustrating a method for displaying a dynamic home screen on a device according to an embodiment;

FIG. 3 is a flowchart illustrating a method for displaying a dynamic home screen respective of an intent according to an embodiment;

FIG. 4 is a schematic block diagram of a search server according to an embodiment;

FIGS. 5A and 5B are screenshots of a dynamic home screen of a device as the user intent changes according to various embodiments;

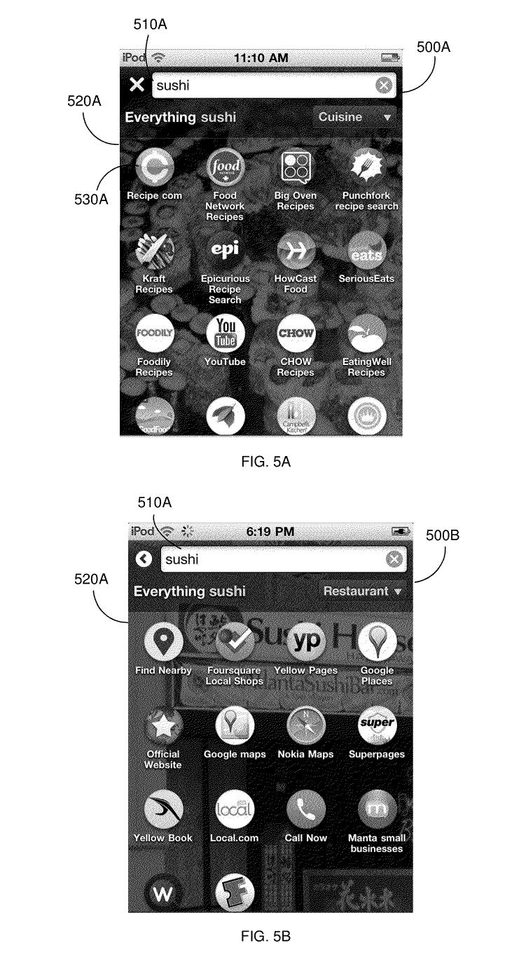

FIG. 6 is a flowchart illustrating a method for displaying a dynamic home screen respective of a user intent provided via a user selection according to an embodiment;

FIG. 7 is a flowchart illustrating a method for displaying a dynamic home screen respective of a user intent according to an embodiment;

FIG. 8 is a screenshot of a mobile device screen displaying a potential user intent on a device according to an embodiment; and

FIG. 9 is a flowchart illustrating a method for providing a bidding platform for display on a user device respective of a user's intent according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

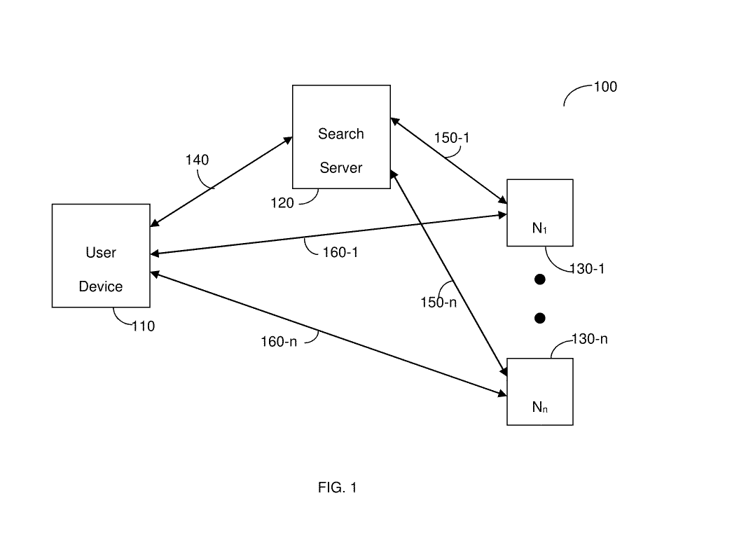

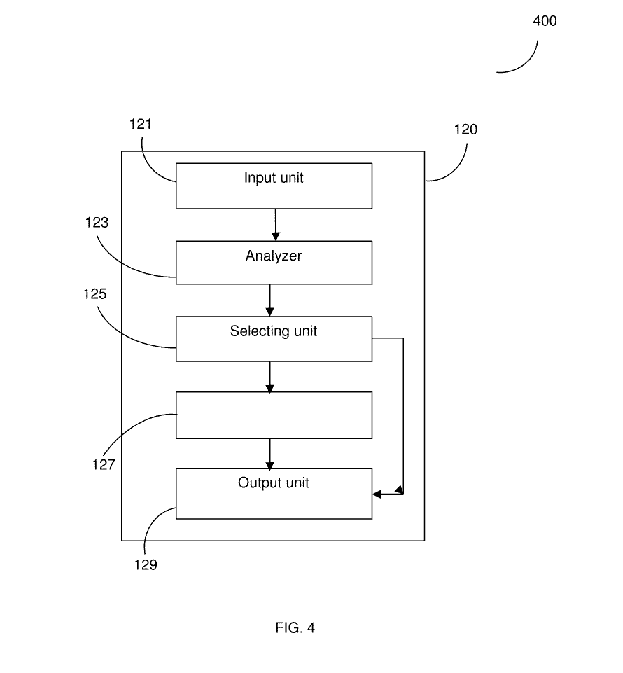

FIG. 1 depicts an exemplary and non-limiting schematic diagram of a system 100 utilized for describing certain embodiments disclosed herein. A user device 110 submits a query to a search server 120 over a communication link 140. The components of the search server 120 are described further herein below with respect to FIG. 4. The search server 120 is configured to receive a plurality of environmental variables. Such environmental variables generally include variables over which users typically have no control such as, for example, the time of day, a location, motion information, weather information, sounds, images, and so on. The environmental variables may be received from databases (not shown) connected to the search server 120 and/or from the user device 110. For example, location information can be received by a GPS in the user device 110, while social friends may be received from a database of a social media website.

In addition, personal variables, such as a user profile, demographic information related to the user, and so on, can be retrieved by the search server 120 and can be utilized to determine the user's intent. The search server 120 determines a potential user intent based on the received variables. With this aim, according to an exemplary embodiment, the search server 120 analyzes the context of each variable and correlates the analyzed variable to derive at least a category of interest. The correlation is performed based on the context of the analyzed variables.

In another embodiment, the search server 120 is configured to determine the potential user intent respective of a query or a part of a query received from the user based on at least one environmental or personal variable. The search server 120 processes the input query and the received variables to determine the potential user intent. With this aim, according to an exemplary embodiment, the search server 120 analyzes the context of the query and each received variable and correlates the analyzed variables with the query to derive at least a category of interest. The correlation is performed based on the context of the analyzed variables and the query. As an example, the search server 120 receives the query “Madonna”. The search server 120 further receives by a GPS in the user device 110 information that the user is located, for example, in New York City. The query is then analyzed by the search server 120 and the potential user intent may be determined as: “the Brooklyn Museum in New York” based on the religious interpretation of the word “Madonna” and/or “buy tickets to Madonna concert in New York and view Madonna video clips,” both based on Madonna the entertainer. Respective of the estimated intents, a plurality of resources are provided by the search server 120 and displayed over a display of the user device 110. The user device 110 receives a selection of the Brooklyn Museum by the user device 110. Such a selection may be, for example, a scroll over a query “Brooklyn Museum” displayed over the user device 110. Respective of the user selection, the user intent is determined as “art” related.

Once the user intent is determined, the search server 120 selects resources from a plurality of resources 130-1 through 130-n that are the most appropriate to fulfill the user intent, i.e., information regarding the Brooklyn Museum. The resources 130 may include, but are not limited to, a plurality of web search engines, a plurality of servers of content providers, vertical comparison engines, servers of content publishers, and so on. The resources 130 may include native applications or “cloud-based” applications, that is, applications executed by servers in a cloud-computing infrastructure such as, but not limited to, a private-cloud, a public-cloud, or any combination thereof. The cloud-computing infrastructure is typically realized through a data center. Although not shown in FIG. 1, the resources 130 may further include mobile applications (also known as apps) and/or widgets currently installed on the user device 110.

The resources 130 may be further arranged according to different categories. For example, several resources may be categorized as capable of handling classical music queries. In that example, if the query term is “Hector Berlioz,” then it is most likely that the best answers will be from the resources that are capable of handling classical music queries.

In an embodiment, the search server 120 is configured to determine which resources 130 would be the most appropriate resource(s) 130 to address the user intent. With this aim, the resources 130 are categorized according to topics of interest such as “music” or “carpentry tools”. The topics of interest are set, for example, by the content provided. The resources 130 are further categorized according to demographic information (i.e., based on which demographic group a certain resource may be of interest to). The resources 130 may also be registered according to certain keywords.

To determine the appropriate resource(s) 130, the search server 120 matches the user intent to resources based on the category of each resource. For example, if the user intent is “building a bookcase”, then resources categorized with the topic of interest “carpentry tools” will be selected. Moreover, as will be described herein below, the search server 120 may monitor the corresponding use by the user on the user device 110 to determine which of the resources 130 were the most appropriate for the user, thereby influencing future references provided from that resource.

The search server 120 further provides a display area containing display segments unique to each of the selected resources 130, which have been determined to be appropriate to address the user's intent. The selected resources communicate directly with their respective display segments on the user device over the communication links 160-1 through 160-n (hereinafter referred to collectively as communication links 160 and individually as a communication link 160, merely for simplicity purposes). The display area may be an application in its own right such as, but not limited to, a web browser.

In one embodiment, and as further explained herein below, only a portion of the selected resources of the resources 130 are displayed in a display segment. Any selected resources that are not displayed in the display segment may be provided when the user requests, for example, information from additional selected resources. For example, there may be thirty selected resources, but the display area may be designed to only contain ten display segments; therefore, only the top ten selected resources are displayed in the display segment. The other selected resources can be associated with the display segment upon a subsequent request for more information made by the user as further explained below. As a result, it is not necessary for the search server 120 to have any specific information or data regarding the actual content residing on the selected resources. The search server 120 merely needs to determine which resources of the resources 130 may be appropriate to provide a certain answer to the user's intent, thereby potentially becoming a resource trusted by a user of the device 110.

According to certain embodiments, the search server 120 generates a query respective of the determined user intent, or variations thereof, to a resource in a format that is proper for that specific resource, thereby enabling searching through resources that utilize a customized searching interface. The communication links 140, 150, and 160 may occur over a common network such as, but not limited to, a local area network (LAN), a wide area network (WAN), a metro area network (MAN), the world wide web (WWW), the Internet, a wired network, a wireless network, and the like, as well as any combination thereof.

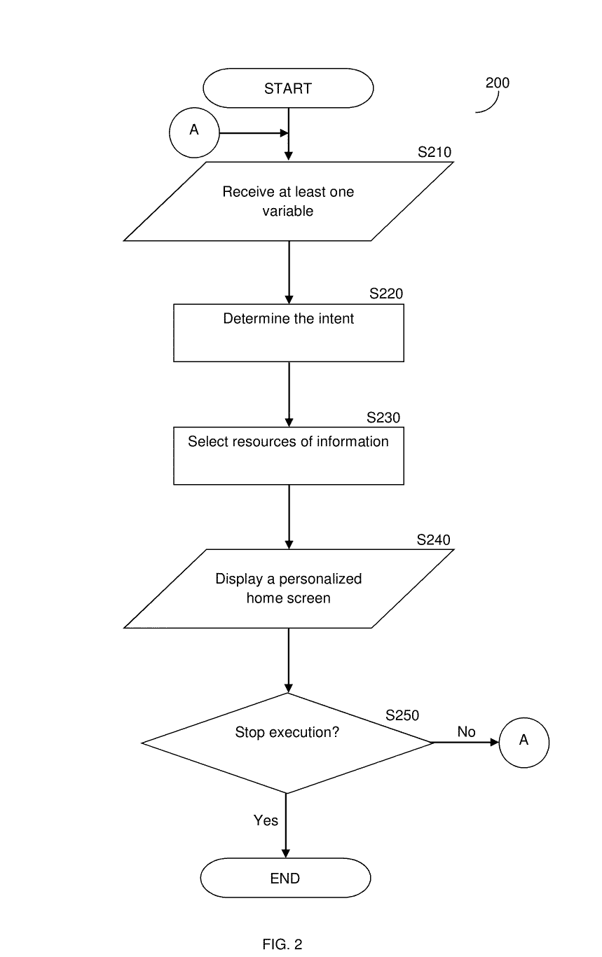

FIG. 2 depicts an exemplary and non-limiting flowchart 200 of a method for generating and displaying a dynamic home screen over a user's device according to an embodiment. In S210, at least one variable is received. Such variables may be environmental variables and/or personal variables. An environmental variable may be, for example and not by way of limitation, the location of the user mobile device, the user mobile device's rate of motion, a time of day, and so on. In one embodiment, the search server 120 may be preconfigured to include a set of variables defined by the system or by the user. For example, “home” could mean the physical location of the user's home, whereas “morning” could mean any time between 6 A.M. and 10 A.M.

Optionally, the search server 120 may also retrieve or receive one or more personal variables associated with the user. As mentioned above, personal variables may include, but are not limited to, a user profile, demographic information, a user's preferences, and so on. Such environmental and/or personal variables may be retrieved or received from systems and databases that generate and/or maintain variables.

In S220, based on the received at least one variable, the intent of the user is determined. The received variables include at least one environmental variable and optionally one or more personal variables. The intent may represent the type of content, the content, and/or actions that may be of an interest to the user at a current time period. In one embodiment, the intent is determined by monitoring at least the received environmental variables (or variables determined by the users to be monitored) to determine any changes in the variables that may in turn change the intent. Then, the changed environmental variables are analyzed to determine the current (updated) intent of the user. The changed environmental variables may be further correlated with the personal variables.

For example, if the time is 8 A.M. on Monday and the location of the user device is the user's home, then the intent may be determined to be related to “review news” or “review emails.” If the location changes to away-from-home, and the GPS information indicates the user is driving, the intent may be changed to receiving traffic updates or listening to the user's favorite radio station during the user's commute. As another example, if the device's motion is determined to be at a rate of a person walking, and the location is determined as 5^{th} Avenue in New York City, the user intent may be “nearby shopping stores.”

In S230, one or more resources of information (e.g., the resources 130) related to the determined intent are selected. For example, if the intent is “review news” (as discussed above), then the selected resources may be one or more news websites or mobiles applications (apps) that the user usually reviews. The favorite news websites or apps may be determined, for example, based on a different environmental variable, such as a search or browsing history), and/or based on a personal variable (e.g., a user profile).

In S240, a personalized home screen is generated to be displayed on the user's device respective of the selected one or more resources. Each selected resource is associated with an icon. An icon may be any type of graphical symbol rendered and displayed over the display on the user device. Clicking or tapping on an icon activates an app or provides a link to an information resource (e.g., news website), thereby providing the user with the desired information and/or action. In one embodiment, an icon included in the personalized home screen may be in a form of a widget or a gadget that can activate and/or provide a link to a respective selected resource. It should be noted that the widget or gadget is associated with a resource or information selected as described in detail above.

In S250, it is checked whether it execution will cease and, if so, execution terminates; otherwise, execution continues with S210.

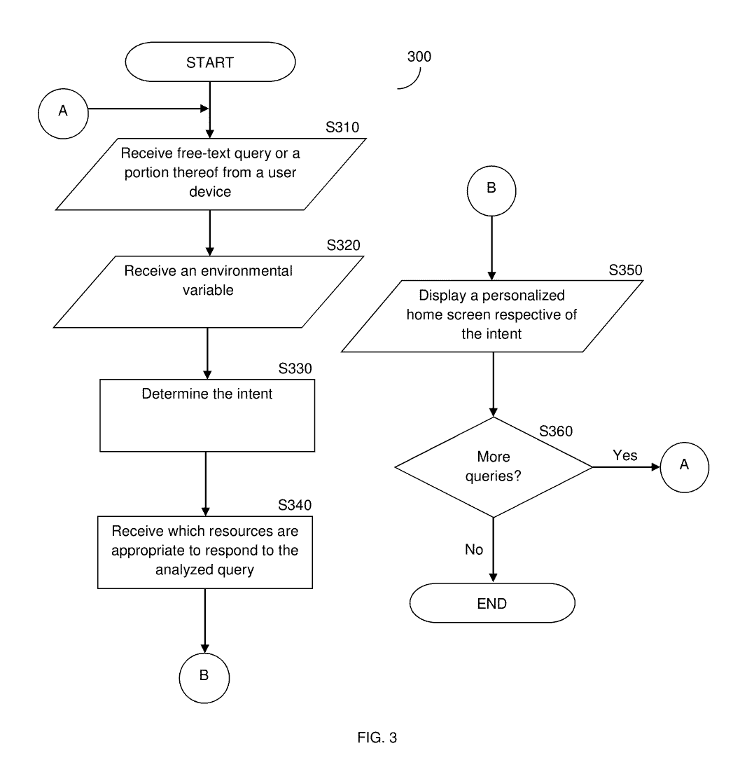

FIG. 3 depicts an exemplary and non-limiting flowchart 300 describing a method for generating and displaying a dynamic home screen respective of a query or part of a query and at least one environmental variable, according to another embodiment. In S310, a query is received. The query may be, for example a free-text query, or a portion thereof, received from a user device (e.g., the user device 110). The query may be, for example, a keyword, a portion of a keyword, a plurality of keywords, a character, a series of characters, and the like. In one embodiment, at least a portion of a query is automatically completed, thereby suggesting at least a query based on, for example, a user experience.

In S320, at least an environmental variable is received. In S330, the user's intent respective of the query is determined based on at least one environmental variable as described in further detail herein above with respect to FIG. 1. The user intent can also be determined using one or more personal variables that may be correlated with the at least an environmental variable.

In S340, a list of relevant resources is determined for the received query respective of the determined intent. In S350, a personalized home screen is generated to include the resources of the list of relevant resources. The generated home screen is displayed over the user's device. As noted above, the selected resource is associated with an icon on the generated home screen. An icon may be any type of graphical symbol rendered and displayed over the display of the user device 110. Clicking or tapping on the icon activates mobile application (app) or provides a link to an information resource (e.g., a news website), thereby providing the user with the desired information and/or action.

As noted above, in one embodiment, an icon included in the personalized home screen may be in a form of a widget or a gadget. It should be noted that the widget or gadget is associated with a resource of information selected as described in detail above. In S360, it is checked whether there are additional queries to handle and, if so, execution continues with S310; otherwise, execution terminates.

The following are non-limiting examples for the operation of the method described with reference to FIG. 3. If the user often enters queries related to high-end brands, resources which are occasionally selected by other users who tend to search high-end brands may be displayed. A time of the day (given as an environmental variable) may further be identified and/or added into the query.

As another example, if the user enters the query term “eat” in the morning, the results related to breakfast would be displayed, and if the user enters the query term “eat” in the evening, responses related to dinner would be displayed. As another example, if the environmental variable is the temperature at the user's location and the input query is “clothing”, resources respective of the temperature and the term clothing may be selected. Examples for resources that may be displayed in response to the query term “clothing” and the environmental variable temperature indicating “winter season” are on-line stores that sell winter clothing. Again, the selected resources are displayed as icons on the home screen of the user's device.

In yet another example, the identified environmental variable is the state of motion of the device, indicating if the user is static or moving. Resources are selected and icons associated with the selected resources are displayed based on this identification and an input query. For instance, if the user enters the query term “Pizza” while moving, resources related to Pizza restaurants are selected. If the user enters the query term “Pizza” while in a static mode, the server 120 displays resources related to Pizza delivery services. Again, the selected resources of information are displayed as icons on the home screen of the user's device, thereby permitting the home screen to be dynamically changed respective of changes in the query and/or in the corresponding variables.

A person of ordinary skill in the art would readily appreciate that the operation of displaying a dynamic home screen as described in FIG. 2, and the operation of displaying a dynamic home screen respective of the intent of a query as described in FIG. 3, may be integrated without departing from the scope of the invention.

FIG. 4 depicts an exemplary and non-limiting schematic diagram 400 of the search server 120 according to an embodiment. In that embodiment, the search server 120 includes an input unit 121 for receiving queries from the user's device 110. Through the input unit 121, a plurality of environmental variables is also received. The search server 120 also includes an analyzer 123, a selection unit 125, a tracking unit 127, and an output unit 129.

Each of the units may include or realize as a processing unit (not shown) coupled to a memory (not shown), the memory containing instructions to be executed by the processing unit. The processing unit may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

The analyzer 123 determines the user intent based one or more environmental and/or personal variables as discussed in detail above. The analyzer 123 can also determine the intent respective of an input query as discussed above. The selection unit 125 selects at least one resource from a plurality of resources of information respective of the determined user intent and extracts at least an icon or a widget respective of each selected resource. The tracking unit 127 continuously tracks changes of the one or more environmental variables and updates the home screen respective of the changes. The output unit 129 generates a new home screen that includes the extracted icons and causes the device to replace a current home screen with the newly-generated home screen.

Screenshot 500A is a home screen generated in response to a determination that the user is at home. In this screenshot, a user has entered the term “sushi” in the search bar 510A. Accordingly, as the term “sushi” is identified, a wallpaper 520A related to an intent regarding sushi as well as an icon for displaying results respective of the intent such as, for example, a resource 530A displaying instructions on how to make sushi at home, are displayed.

Screenshot 500B is a home screen generated in response to the determination that the user is away from home, and responsive to the query term “sushi.” The screenshot 500B displays as a result, icons related to the new intent such as, for example, a link to a website 510B specifying sushi restaurants near the current location of the user.

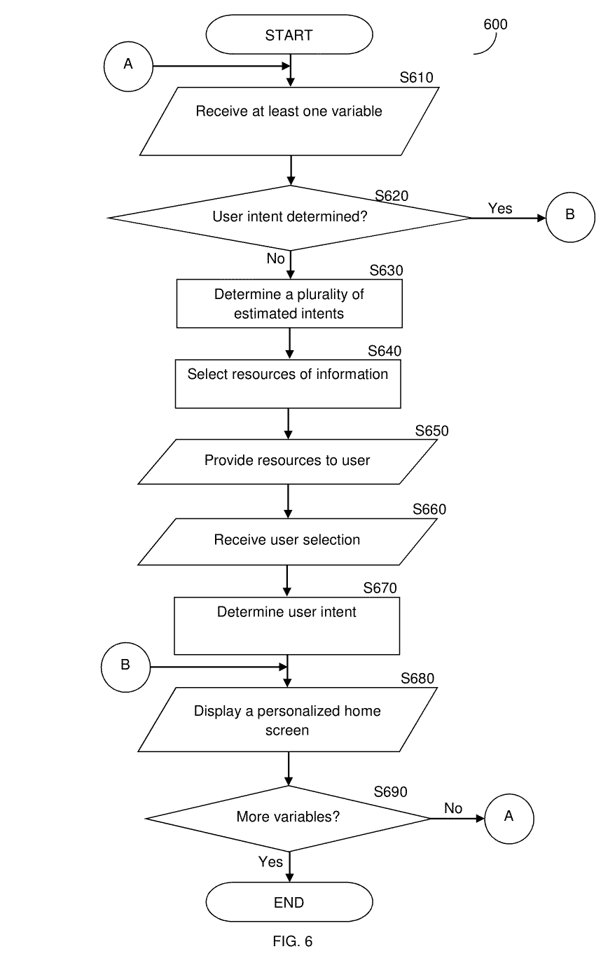

FIG. 6 depicts an exemplary and non-limiting flowchart 600 of a method for generating and displaying a dynamic home screen on the display of a user's device respective of a user intent provided via a user selection according to an embodiment. In S610, at least one variable is received. The at least one variable includes at least one environmental variable, and may include at least one personal variable.

In S620, it is checked if whether the user intent has been determined and, if so, execution continues with S670; otherwise, execution continues with S630. In S630, based on the received at least one variable, a plurality of potential user intents are determined. The received at least one variable includes at least one of: environmental variables, or personal variables. The potential user intents may represent the type of content, the content, and/or actions that may be of an interest to the user at a current time period. In one embodiment, the potential user intents are determined by monitoring at least the received environmental variables (or variables determined by the users to be monitored) to determine any changes in the variables that may in turn change the estimated intents.

In S640, resources from a plurality of resources that are the most appropriate to fulfill each of the plurality of potential user intents are selected. For example, when the user device is identified as moving at a running pace, several intents may be estimated and therefore several resources are identified as appropriate, for example, sport applications, music applications, and so on. As another example, when the user device is identified as moving at a driving pace, navigation applications may be determined as appropriate.

In S650, a personalized home screen respective of the selected resources is generated to be displayed on the user's device. The personalized home screen includes a plurality of display segments, each representing a resource of the plurality of selected resources. According to one embodiment, the display of the user device may be partitioned into several portions, wherein each portion contains at least one resource selected as appropriate to serve a potential user intent.

In S660, a user selection of a potential user intent is received. The user selection may be received by a gesture over the display of the user device. The user's gesture may be: a scroll on the portion of the display, a press on the portion of the display, and/or a response to the portion of the display, and so on. The gesture may further be a tilt of the user device.

In S670, respective of the user selection, the user intent is determined. According to another embodiment, in case a user's selection is not received after a certain period of time, the user intent may be determined as being different from the potential user intents and, therefore, other resources may be provided. According to one embodiment, the user intent is explicitly received from the user and the personalized home screen is displayed respective thereto.

In S680, a personalized home screen is generated to be displayed on the user's device respective of the user. In S690, it is checked whether there are additional variables and, if so, execution continues with S610; otherwise, execution terminates.

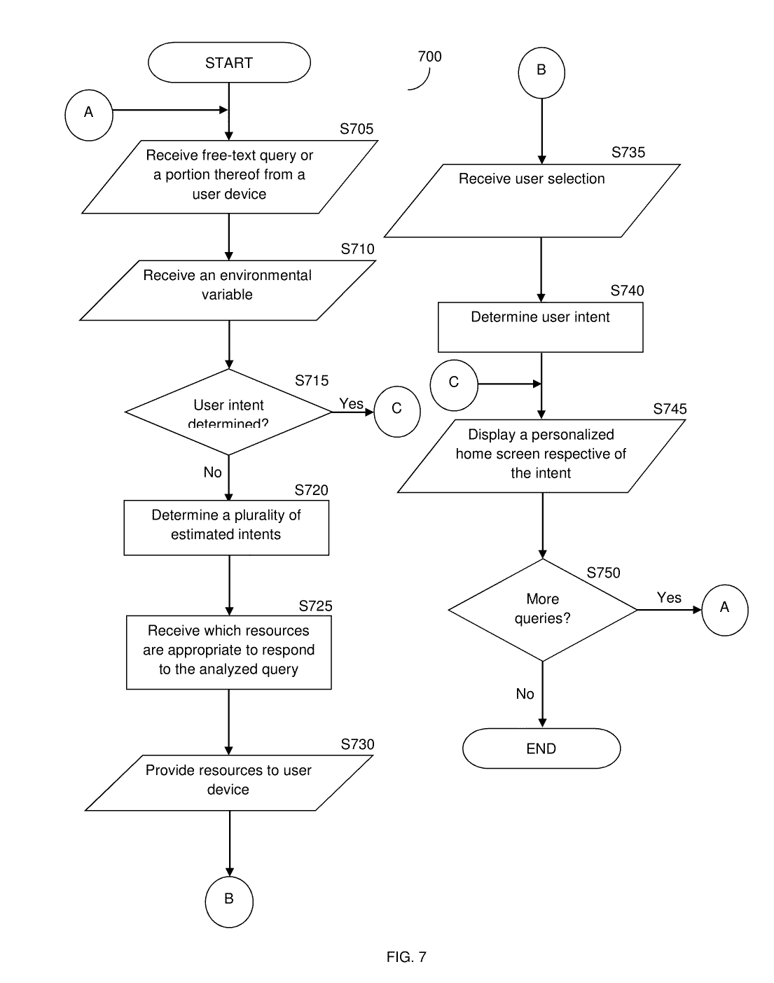

FIG. 7 depicts an exemplary and non-limiting flowchart 700 describing a method for generating and displaying a dynamic home screen respective of a query or part of a query and at least one environmental variable according to another embodiment. In S705, a query, such as a free-text query, or a portion thereof, is received from a user device (e.g., the user device 110). The query may be, for example, a keyword, a portion of a keyword, a plurality of keywords, a character, a series of characters, and the like.

According to one embodiment, at least a portion of a query is automatically completed based on, for example, a user experience. In another embodiment, the user does not need to provide a query or a portion of a query because the query may be suggested to the user respective of the user experience without user entry of a query or a portion of a query. A user experience may include, but is not limited to, a search history, a browsing history, a user profile, content viewed by the user, an upload, a download, movement of the user, and so on. According to another embodiment, the user experience may be further used for correction of the spelling of the query and/or for disambiguation of the query.

As a non-limiting example of disambiguation a query based on a user experience, if a user enters a part of a query “dark ch” and the user's browser history indicates that the user has previously viewed articles regarding recipes involving dark chocolate, the query may be automatically completed as “dark chocolate recipes” rather than “buy dark chocolate.” As a non-limiting example of correction of a query based on a user experience, if the user enters a part of a query “dark chicilate,” the user experience may be utilized to determine that the part of the query should actually be spelled “dark chocolate.”

In S710, at least an environmental variable is received. In an embodiment, one or more personal variables may also be received. Environmental and personal variables are described further herein above with respect to FIG. 1. In S715, it is checked whether the user intent has been determined and, if so, execution continues with S745; otherwise, execution continues with S720. In S720, a plurality of potential user intents are determined respective of the received query and based on the at least one environmental variable. Determination of potential user intents is described further herein above with respect to FIG. 6. The potential user intents can also be determined using one or more personal variables that may be correlated with the environmental variables.

In S725, a list of relevant resources from a plurality of resources (e.g. the plurality of resources 130-1 through 130-n) is determined for the received query respective of the determined plurality of potential user intents. In S730, a personalized home screen is generated to include resources of the list of relevant resources that are relevant to each user intent of the plurality of potential user intents. In an embodiment, when a limited number of resources of the list of relevant resources can be displayed on the user device, one resource per potential user intent may be shown. In a further embodiment, if additional resources beyond the one resource per potential user intent can be displayed, the display of the user device may be populated with additional resources. As a non-limiting example, if there are 5 potential user intents and the display can reasonably accommodate 8 resources, one resource associated with each potential user intent may be displayed. Alternatively, the one resource associated with each potential user intent may be displayed alongside 3 additional resources that may be, e.g., randomly selected from the remaining resources of the list of relevant resources. The generated home screen is displayed over the user's device.

In S735, a user selection of a resource is received. User selections of resources are described further herein above with respect to FIG. 6. In S740, respective of the user selection, the user intent is determined. In S745, a personalized home screen is generated to include resources of the plurality of resources that are relevant to the determined user intent. In S750, it is checked whether execution will continue and, if so, execution continues with S705; otherwise, execution terminates.

As an example, if the user enters the query term “Madonna”, the user intent may be watching video clips of the entertainer Madonna, buying tickets to a Madonna concert, and so on. In such a case, a resource to a streaming website showing Madonna's video clip may be determined as appropriate to serve one potential user intent and a resource that allows the user to purchase tickets to Madonna's performance in New York city may be determined as appropriate to serve a different user intent. Therefore, links to such resources will be displayed over the display of the user device. In case where the user scrolled over the icon of the resource to a streaming website showing Madonna's video clip, one or more resources determined as appropriate to serve the intent “watch Madonna's video clips” will be displayed over the display of the user device.

A person of ordinary skill in the art would readily appreciate that the operation of displaying a dynamic home screen as described in FIG. 6, and the operation of displaying a dynamic home screen respective of the intent of a query as described in FIG. 7, may be integrated without departing from the scope of the invention.

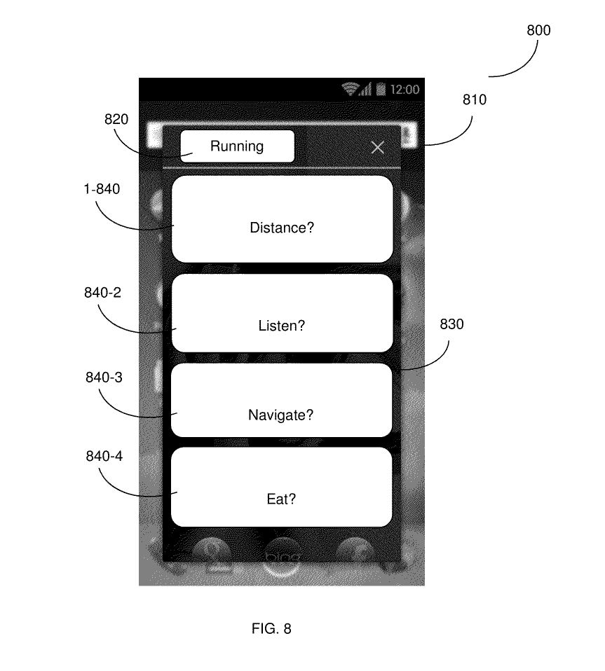

FIG. 8 shows an exemplary and non-limiting screenshot 800 of a screen of a typical mobile device 810. The user is identified as moving at a running pace and, therefore, the suggested input query 820 is “running”. A display segment 830 is provided over which several potential user intents are determined. The several potential user intents are displayed on the user device as tabs 840-1 through 840-4 (hereinafter referred to collectively as tabs 840 or individually as a tab 840, merely for simplicity purposes), wherein each tab 840 represents an potential user intent.

Upon receiving a gesture from a user such as a click over a tab 840, the user intent is determined respective thereto. In accordance with the tabs 840 seen in FIG. 8, a gesture respective of tab 840-1 (“Distance?”) will yield a determination that the user intent is “determining a distance from a starting point.” A gesture respective of tab 840-2 (“Listen?”) will yield a determination that the user intent is “listening to the user's favorite radio station.” A gesture respective of tab 840-3 (“Navigate?”) will yield a determination that the user intent is “navigating to a specific place.” A gesture respective of tab 840-4 (“Eat?”) will yield a determination that the user intent is “finding a nearby restaurant to eat at.”

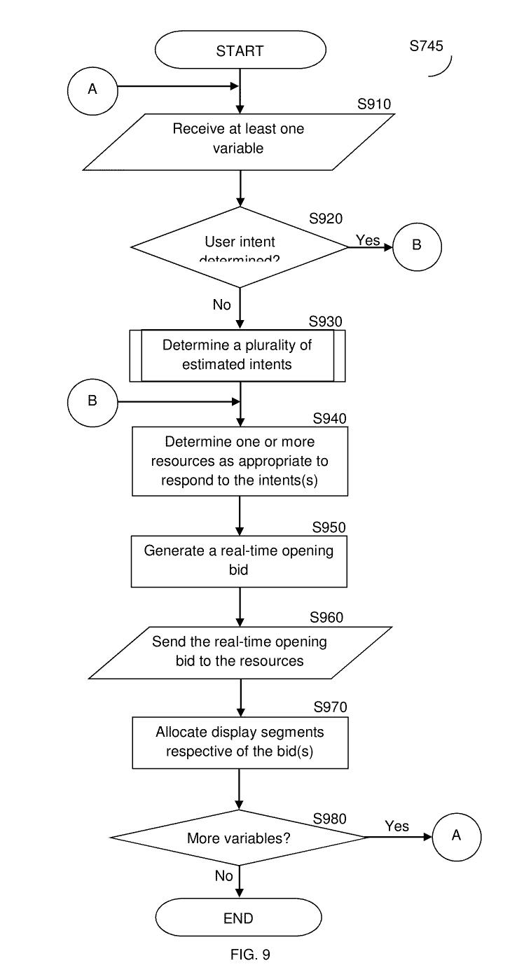

FIG. 9 shows an exemplary and non-limiting flowchart 900 of a method for providing a bidding platform based on a user intent according to an embodiment. In S910, at least one variable, personal or environmental, is received from a user device (e.g., the user device 110). In S920, it is checked whether the user intent is determined based on the at least one variable received and, if so, execution continues with S940; otherwise, execution continues with S930. In S930, a plurality of potential user intents is determined respective of the at least one variable. Determination of potential user intents is described hereinabove with respect to FIG. 6. In S940, one or more resources are determined to be appropriate to serve each of the potential user intents, respectfully.

In S950, a real-time opening bid is generated respective of the user intent(s). A bid is an offer (typically of money) made by a resource operator that, if greater than any or all other offers, will be accepted as payment in exchange for displaying the operator's resource. An opening bid is the minimum offer that will be accepted. The generation of the opening bid is based on the type of the intent. As an example, when the user intent is more urgent, the price of placing an advertisement and, therefore, the opening bid on the user device is higher. According to another embodiment, the opening bid is generated respective of the type of service or product the user intends to consume or purchase. As an example, the opening bid for a user intent related to purchasing an expensive item (e.g., jewelry) will tend to be higher than an opening bid for a user intent related to a less expensive item (e.g., a movie ticket).

In S960, the real-time opening bid is sent to operators of the resources. In S970, the system allocates display segments within the display of the user device to the operator(s) that provided the highest ranked bid(s). The rank of a bid may be based on, but is not limited to, the relative monetary value of the bid (higher bids may be greater), the relative response time of the bid (faster bids may be greater), the relative relevance of the bidder's resource to the user intent (more relevant resources may be associated with greater bids), combinations thereof, and so on.

In an embodiment, the allocation of the display segments may be based on, for example, a rank assigned to each of the bids. Allocation of the display segments may be based on, e.g., locations of resources within the display, lengths of time for displaying resources, relative sizes of resources, and so on. In an embodiment where allocation of the display segments are based on lengths of time for displaying the resources, a resource or a group of resources may be displayed for a limited period of time before a new resource or group of resources is displayed instead. The highest ranked bids will typically receive the allocation that is best for attracting users to select the resource, while lower ranked bids will receive less favorable allocations.

In S980, it is checked whether additional variables have been received and, if so, execution continues with S910; otherwise, execution terminates.

As a non-limiting example, environmental parameters related to the user indicate that the user intent is “having lunch in Paris.” Such a user intent may be determined based on the user location and the current time in Paris (e.g., noon). Respective of the user intent, one or more websites recommending restaurants in Paris are determined as appropriate to serve the user intent. Respective thereto, an opening bid for purchasing a display segment on the display of the user device is 110 generated and sent to the operators of various restaurant-recommending websites. In this example, the upper portion of the display is deemed to be the best allocation for a resource. Further, in this example, the greatest bid is the highest bid. Thus, the upper portion of the display of the user device is allocated to the operator that responded with the highest bid.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating real-time bids based on a user intent, comprising:
receiving at least one variable from a user device;
determining a user intent of a user of the user device at least based on the at least one variable;
selecting a plurality of resources of information respective of the user intent;
generating, in real-time, an opening bid to purchase at least one display segment on a display of the user device at least based on the user intent; and
sending the opening bid to a plurality of operators of the plurality of resources of information.

2. The method of claim 1, wherein the at least one variable is at least one of: a personal variable, and an environmental variable.

3. The method of claim 1, wherein determining the user intent further comprises:
determining a plurality of potential user intents based on the at least one variable;
providing at least one potential user intent of the plurality of potential user intents to the user;
receiving a selection of a potential user intent from the user; and
determining the selected potential user intent as the user intent.

4. The method of claim 1, wherein determining the user intent is further based on at least one of: a query, and a portion of a query.

5. The method of claim 1, wherein generating the opening bid is based on at least one of: a type of the user intent, and an urgency of the user intent.

6. The method of claim 1, further comprising:
receiving at least one bid from at least one operator of the plurality of operators;
determining a plurality of ranks, wherein each rank of the plurality of ranks is assigned to a bid of the at least one bid;
selecting, based on each rank of the plurality of ranks, at least one resource associated with at least one operator of the plurality of operators for display on the user device;
allocating, respective of each rank, a display segment to each of the selected at least one resource.

7. The method of claim 6, wherein determining each rank of the plurality of ranks is based on at least one of: a relative monetary value of the bid, a relative response time of the bid, and a relative relevance of the resource associated with the bid to the user intent.

8. The method of claim 6, wherein the allocation of each display segment is based on at least one of: a location of a resource, a length of time for displaying the resource, and a size of the resource.

9. The method of claim 6, further comprising:
generating a personalized home screen on the user device at least respective of the allocated display segments.

10. A non-transitory computer readable medium having stored thereon instructions for causing one or more processing units to execute the method according to claim 1.

11. A system for generating real-time bids respective of a user intent, comprising:
an analyzer for determining a user intent;
a processor; and
a memory communicatively connected to the processor, the memory containing instructions that, when executed by the processor, configure the system to:
receive at least one variable from a user device;
determine the user intent of a user of the user device at least based on the at least one variable;
select a plurality of resources of information respective of the user intent;
generate, in real-time, an opening bid to purchase at least one display segment on a display of the user device at least based on the user intent; and
send the opening bid to a plurality of operators of the plurality of resources of information.

12. The system of claim 11, wherein the at least one variable is at least one of: a personal variable, and an environmental variable.

13. The system of claim 11, wherein the system is further configured to:
determine a plurality of potential user intents based on the at least one variable;
provide at least one potential user intent of the plurality of potential user intents to the user;
receive a selection of a potential user intent from the user; and
determine the selected potential user intent as the user intent.

14. The system of claim 11, wherein determining the user intent is further based on at least one of: a query, and a portion of a query.

15. The system of claim 11, wherein generating the opening bid is based on at least one of: a type of the user intent, and an urgency of the user intent.

16. The system of claim 11, wherein the system is further configured to:
receive at least one bid from at least one operator of the plurality of operators;
determine a plurality of ranks, wherein each rank of the plurality of ranks is assigned to a bid of the at least one bid;
select, based on each rank of the plurality of ranks, at least one resource associated with at least one operator of the plurality of operators for display on the user device;
allocate, respective of each rank, a display segment to each of the selected at least one resource.

17. The system of claim 16, wherein determining each rank of the plurality of ranks is based on at least one of: a relative monetary value of the bid, a relative response time of the bid, and a relative relevance of the resource associated with the bid to the user intent.

18. The system of claim 16, wherein the allocation of each display segment is based on at least one of: a location of a resource, a length of time for displaying the resource, and a size of the resource.

19. The system of claim 16, wherein the system is further configured to: generate a personalized home screen on the user device at least respective of the allocated display segments.
